(19) United States
(12) Patent Application Publication
(10) Pub. No.: US 2014/0198074 A1
(43) Pub. Date: Jul. 17, 2014

(54) PORTABLE COMPUTER

(71) Applicant: Shih Hua Technology Ltd., Zhubei City (TW)

(72) Inventor: HO-CHIEN WU, Hsinchu (TW)

(73) Assignee: SHIH HUA TECHNOLOGY LTD., Zhubei City (TW)

(21) Appl. No.: 13/903,963

(22) Filed: May 28, 2013

Related U.S. Application Data
(60) Provisional application No. 61/752,930, filed on Jan. 15, 2013.

(51) Int. Cl. G06F 3/044; G06F 3/045

(52) U.S. Cl. CPC G06F 3/044; G06F 3/045; Y10S 977/952
USPC 345/174; 977/952

(57) ABSTRACT

A computer includes a display screen, a computer body, a keyboard input portion and a touch input device. The computer body is connected with the display screen vie a connecting piece. The touch input device includes a touch panel. The keyboard input portion and the touch panel are located on a same surface of the computer body. The touch panel extends from one side to another side of the surface, and covers the whole surface of the computer body with the keyboard input portion.

### BACKGROUND

1. Technical Field

The present disclosure relates to a portable computer, especially relates to a touch input type portable computer.

2. Description of Related Art

Conventional portable computers include display panels and computer bodies connected to the display panels. A keyboard and a touch pad are located on a surface of the computer body. The touch pad is used to operate as a mouse to control the software shown on the display panel, to control on and off of all kinds functions of the portable computer. However, the operation of the conventional portable computer is not convenient, because the touch pad on the conventional portable computer has a small region, and the areas around the touch pad is wasted. Furthermore, the touch pad only functions to control mouse input, the function of the touch pad is too simple, which limits the application of the conventional portable computer.

What is needed, therefore, is to provide a portable computer with a touch panel including a plurality of touch function regions, which can overcome the shortcoming described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic structural view of one embodiment of a portable computer.

FIG. 2 is a schematic structural view of a touch panel of the portable computer in FIG. 1.

FIG. 3 is a schematic view of the touch function region of the touch panel of the portable computer in FIG. 1.

FIG. 4 is a top structural view of the touch panel of the first embodiment.

FIG. 5 is an explosive view of the touch panel in FIG. 4. of the first embodiment.

FIG. 6 is a cross-sectional view of the touch panel along line VI-VI of FIG. 4.

FIG. 7 is a schematic view of a carbon nanotube film.

FIG. 8 is a schematic structural view of another embodiment of a portable computer.

FIG. 9 is a schematic view of an input display device of a touch input device of the portable computer in FIG. 8.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

References will now be made to the drawings to describe, in detail, various embodiments of the present capacitance touch panels.

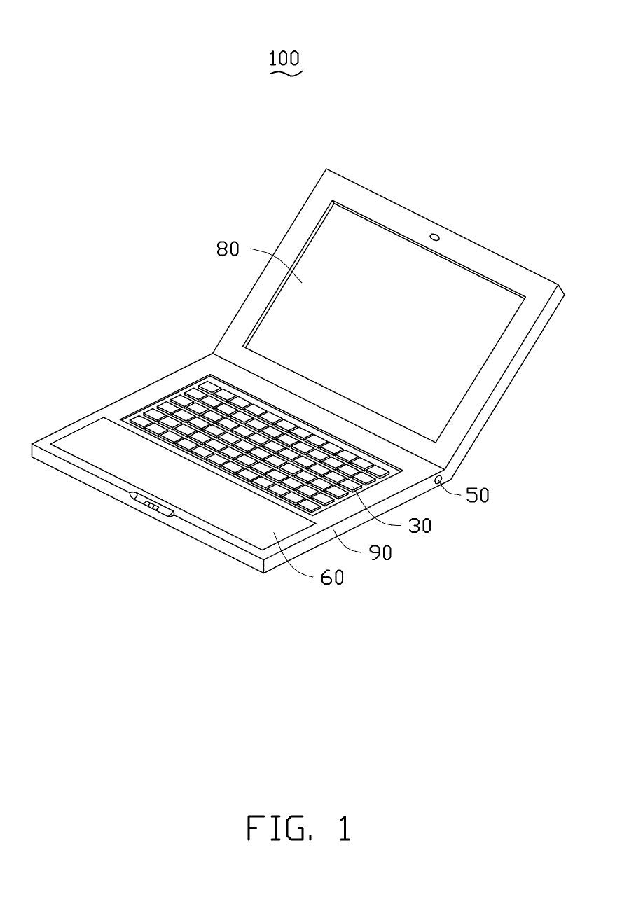

FIG. 1 is a first embodiment of the present disclosure of a portable computer 100. One embodiment of the portable computer 100i includes a display screen 80 and a computer body 90. The computer body 90 is connected to the display screen 80 via a connecting piece 50. The display screen 80 can fold, count rotate, and unwind to the computer body 90. The computer body 90 is electrically connected to the display screen 80 via data wires. A keyboard input portion 30 and a touch input device 60 are located on a surface of the computer body 90.

The display screen 80 may be one of a liquid crystal display screen, a field emission display screen, a plasma display screen, an electroluminescent display screen, and a vacuum fluorescent display screen. In one embodiment, the display screen 80 is a liquid crystal display screen.

The touch input device 60 includes a touch panel 200. The touch panel 200 and the keyboard input portion 30 are located on a same surface of the computer body 90. The surface of the computer body 90 faces to the display screen 80. The display screen 80 can fold, count rotate, and unwind to the surface of computer body 90. In one embodiment, the keyboard input portion 30 is close to the connecting piece 50, and the touch panel 200 is away from the connecting piece 50. The touch input device 60 can be electrically connected to the computer body 90 via date wires. The touch panel 200 extends from a first side to a second side of the surface of computer body 90, where the first side is opposite to the second side, and the touch panel 200 shares the whole surface of the computer body 90 with the keyboard input portion 30. Because the touch panel 200 extends from the first side to the second side of the surface of the computer body 90, the touch panel 200 has a great area, which is convenient to operate. Further, the touch panel 200 and the keyboard input portion 30 cover the whole surface of the computer body 90, the whole surface of the computer body 90 is entirely used, and no area is wasted. Furthermore, the position of the touch panel 200 and the keyboard input portion 30 is not limited to above description, and can be aligned from left to right, which means the touch panel 200 and the keyboard input portion 30 are located on the same side of the connecting piece 50. The touch panel 200 and the keyboard input portion 30's position can be designed according to actual applications.

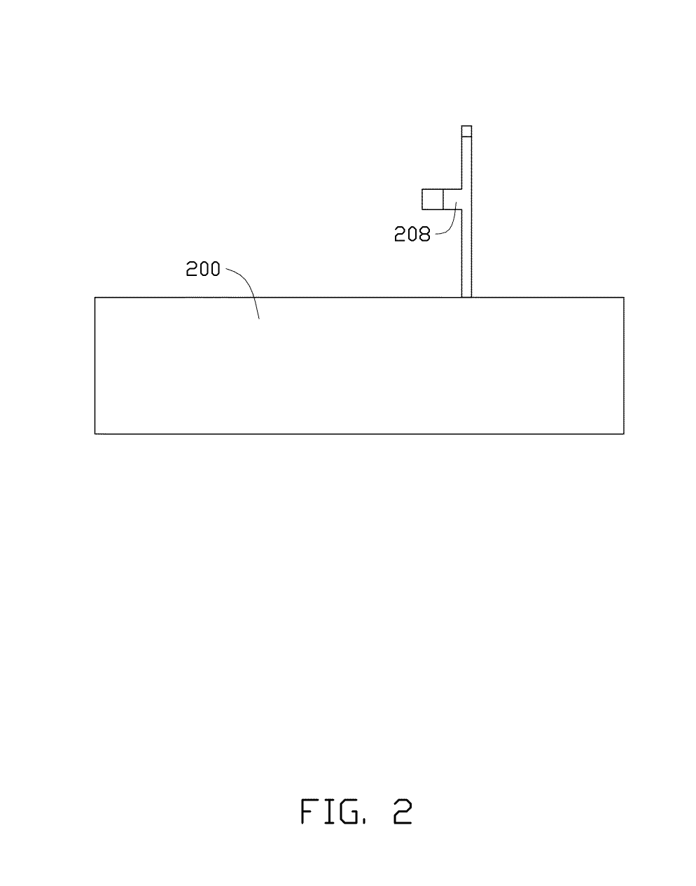

FIG. 2 shows that in one embodiment, the touch panel 200 of the touch input device 60 can be electrically connected to a central processor in the computer body 90 via date wire 208. The date wire 208 can be built in the computer body 90. Additionally, the touch input device 60 can be electrically connected to the computer body 90 wirelessly. The touch input device 60 can be integrated on the surface of the computer body 90 or detachable fixed on the surface of the computer body 90. Furthermore, the touch input device 60 can further includes a second display screen integrated with the touch panel 200.

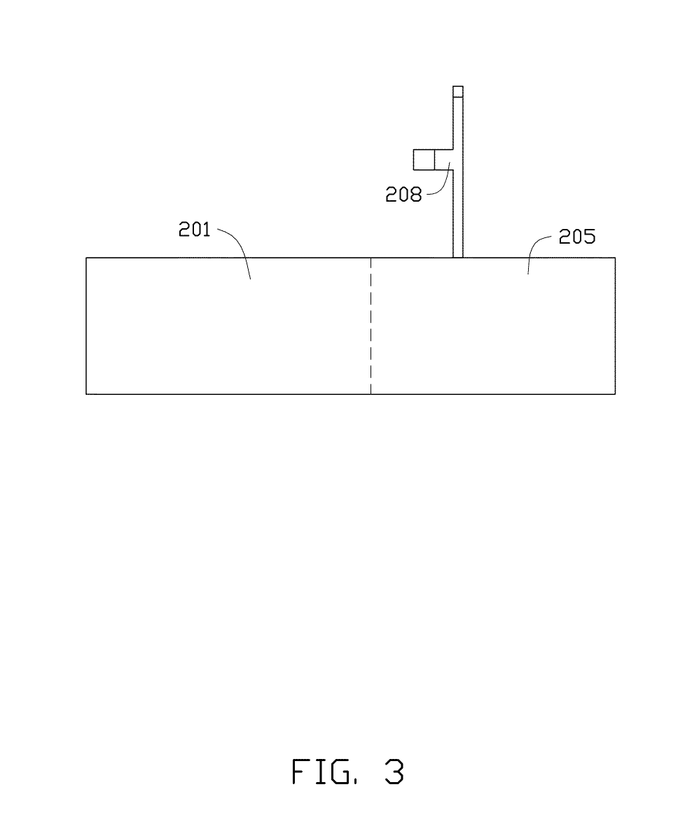

FIG. 3 shows that a conventional portable computer touch pad. The touch panel 200 includes at least two touch function regions. The at least two touch function regions can define different functions according to different coordinates that the touch panel 200 senses. According to actual needs, the touch panel 200 can define a plurality of touch function regions, such as game region, daily life management region, drawing table region, for example, to transfer quickly between different functions. Furthermore, the touch panel 200 can define a keyboard function region to assist the keyboard input portion 30.

In one embodiment, the touch panel 200 defines two touch function regions: a mouse touch function region 201, and a handwriting function region 205. Specifically, when a user touches the mouse touch function region 201, mouse moving and click can be operated. When the hand of the user moves from the mouse touch function region 201 to the handwriting function region 205, the input terminal system transfers from a mouse input function to a handwriting function, for operation of the handwriting function.

The touch panel 200 can be a capacitive or resistive touch panel, and can achieve multi touch function. The touch panel 200 can be a conventional ITO touch panel, or a carbon nanotube touch panel. In one embodiment, the touch panel 200 is a capacitive carbon nanotube touch panel. The transparent conductive layer of the touch panel 200 includes a carbon nanotube film.

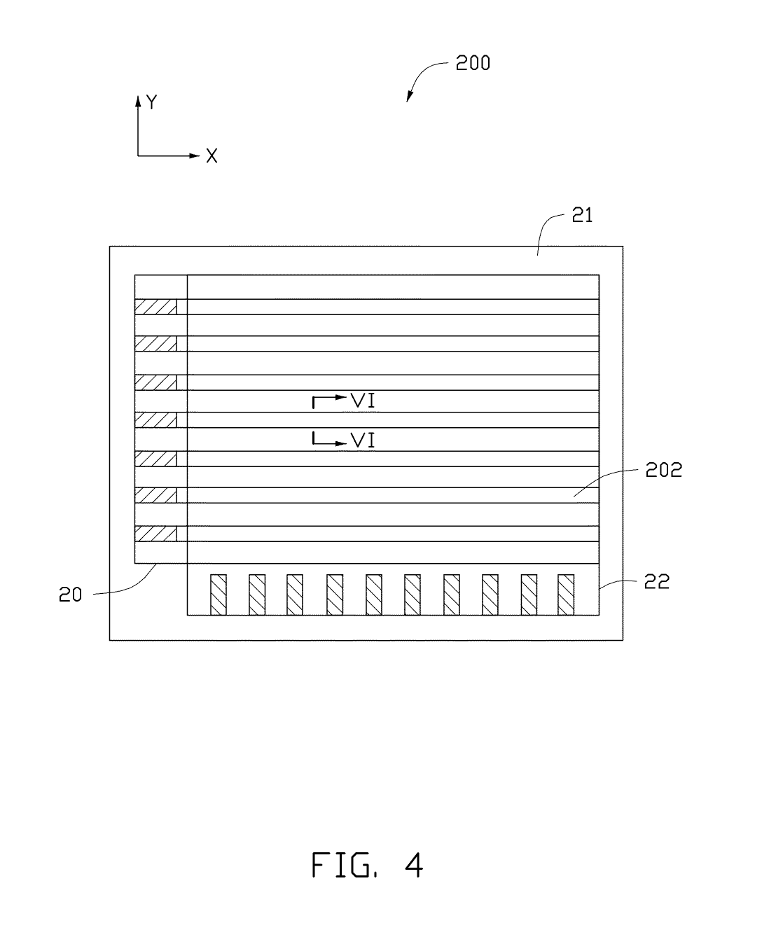

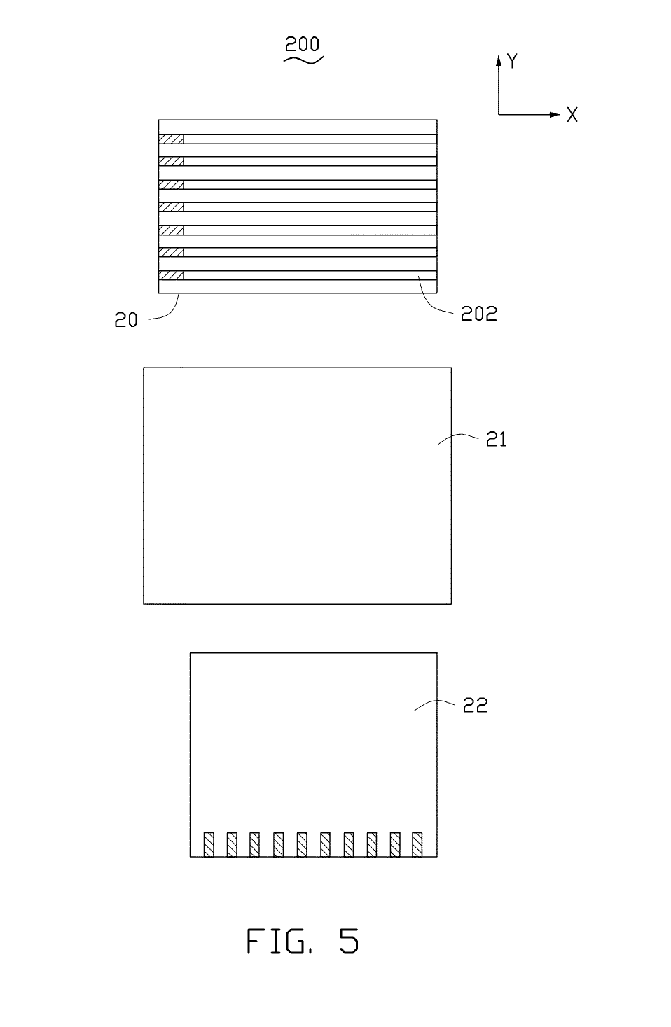

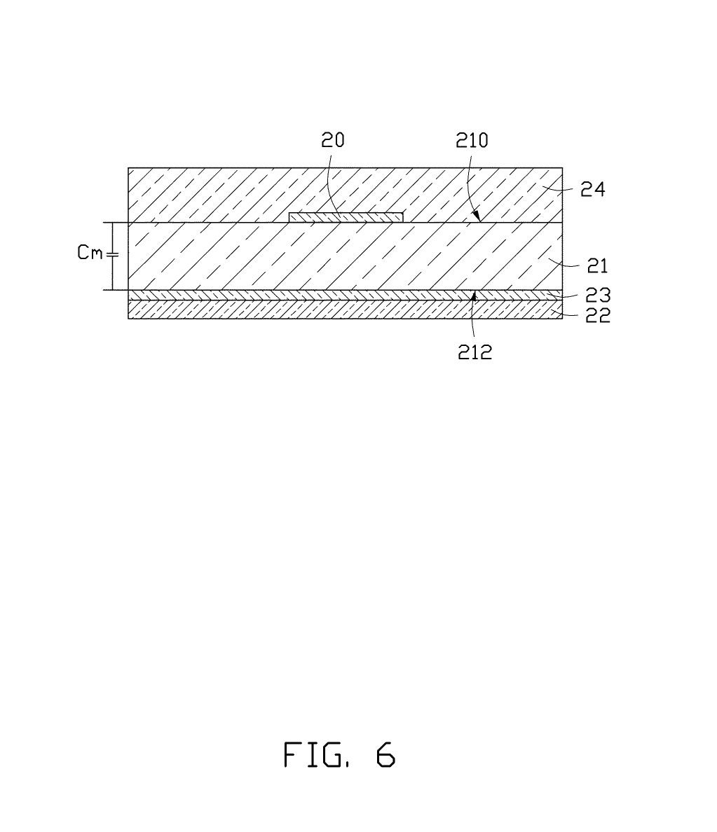

FIG. 4, FIG. 5 and FIG. 6 show that the touch panel 200 of the embodiment includes a first conductive film 20, a second conductive film 22, and an insulated substrate 21. The insulated substrate 21 is sandwiched between the first conductive film 20 and the second conductive film 21. The touch panel 200 is a capacitance touch panel.

FIG. 6 shows that the insulated substrate 21, includes a first surface 210 and a second surface 212 opposite to each other. The first conductive film 20 is located on the first surface 210 of the insulated substrate 21. The second conductive film 22 is located on the second surface 212 of the insulated substrate 21. The first conductive film 20 and the second conductive film 22 are electrical resistance anisotropy. A minimum electrical resistance direction of the first conductive film 20 is perpendicular to a minimum electrical resistance direction of the second conductive film 22.

The first conductive film 20 includes a plurality of patterned conductive structures 202, such as strip-type conductive structures 202. The strip-type conductive structures 202 are parallel to and spaced a distance from each other. In one embodiment, the first conductive film 20 is a patterned ITO film. The first conductive film 20 can be other conventional materials or electrical patterned resistance anisotropy films. In one embodiment, a ratio between the width of the strip-type conductive structure 202 and a distance between the adjacent strip-type conductive structures 202 is about 5%-50%. For example, when the distance between the adjacent strip-type conductive structures 202 is 5 millimeters (mm), the width of the strip-type conductive structure 202 is about 0.25-2.5 mm. The strip-type conductive structures 202 extend along a first direction (the X axis in FIG. 4 and FIG. 5), which forms a plurality of conductive passages along the first direction.

The existed distance between the adjacent strip-type conductive structures 202 would increase the electrical field interference level between the first conductive film 20 and the second conductive film 22. Thus, the sensitivity of the touch panel 200 is increased. In one embodiment, the width of the long strip-type conductive structure 202 and the distance between the adjacent long strip-type conductive structures 202 is a range from about 10% to about 20%, the sensitivity of the touch panel 200 is highly increased.

The insulated substrate 21 mainly provides support, and has a planar structure and is transparent. The insulated substrate 21 can be made of hard materials, such as glass, quartz, diamond, or soft materials, such as, plastic, resin for example. In the embodiment, when the insulated substrate 21 is made of a soft material, the soft material can be polycarbonate (PC), polymethylmethacrylate (PMMA), polyethylene terephthalate (PET), polyether sulfone (PES), cellulose ester, Benzocyclobutene (BCB), polyvinylchloride (PVC), and acrylic resin. In one embodiment, the material of the insulated substrate 21 is glass, with a thickness of 1 millimeter. The material of the insulated substrate 21 is not limited to above descriptions, all of the transparent insulated substrate 21 with supporting function, is in the protection of the present disclosure.

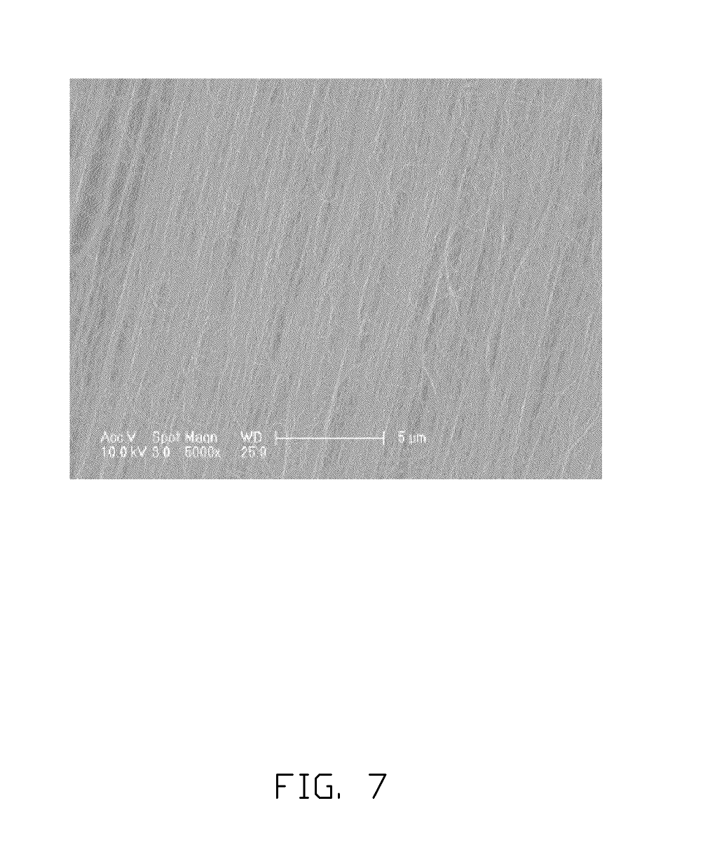

The second conductive film 22 is an electrical resistance anisotropy conductive film. The second conductive film 22 has a minimum electrical resistance along a second direction (Y axis in FIG. 4 and FIG. 5), and has a maximum electrical resistance along the first direction. In some embodiments, the conductive direction of the conductive structure 202 of the first conductive film 20 is perpendicular to the direction of the minimum electrical resistance of the second conductive film 22. In one embodiment, the second conductive film 22 is a carbon nanotube (CNT) film. A SEM image of the carbon nanotube film is shown in FIG. 7. The carbon nanotube film is manufactured by the method: first, carbon nanotubes are grown, and then a plurality of carbon nanotubes is pulled out end to end. The carbon nanotube film includes a plurality of carbon nanotubes oriented along the pulling direction, and joined end to end by van der Waals forces along the pulling direction. The carbon nanotube film has a minimum electrical resistance along the pulling direction, and has a maximum electrical resistance along a direction perpendicular to the pulling direction, to obtain an electrical resistance anisotropy conductive film.

FIG. 6 shows that the second conductive film 22 can be adhered on the second surface 212 of the insulated substrate 21 by an adhesive 23. The adhesive 23 is transparent. The carbon nanotube film is directly adhered on the second surface 212 of the insulated substrate 21 via the adhesive 23. Because the adhesive 23 is transparent, not only the structure of the touch panel is simplified, but also the transparency of the touch panel 200 is increased. The adhesive 23 can be pressure sensitive adhesive, heat sensitive adhesive, or light sensitive adhesive. The thickness of the adhesive 23 is not suitable to be too thick, and is suitable in a range from 4 micrometers to 8 micrometers. In one embodiment, the adhesive 23 is UV adhesive, with a thickness of 5 micrometers.

In one embodiment, the first conductive film 20 and the second conductive film 22 of the touch panel 200 have a same structure, which means both of them is made of carbon nanotube film, and are adhered directly on the first surface 210 and the second surface 212 of the insulated substrate 21 respectively. In this condition, the alignment directions of the carbon nanotubes in the first conductive film 20 and the second conductive film 22 are perpendicular to each other.

In addition, as shown in FIG. 6, the touch panel 200 can also include a protection layer 24 covering the first conductive film 20 on the first surface 210. The material of the protect layer 24 can be conventional transparent insulated materials, such as Polyethylene (PE), Polycarbonate (PC), Polyethylene Terephthalate (PET), PolyMethyl MethAcrylate (PMMA), and thin glass.

The computer body 90 includes motherboard, central process union (CPU), memory, and hard disk, for example. The motherboard includes system bus, data bus, control bus, slots, ports, for example. CPU, memory, video card, sound card, network card, and TV tuner card can be installed on the motherboard. The hard disk and power source are electrically connected to the motherboard via electrical wires. The video card can transfer the signal processed by the computer body 90 to the display screen 80. Furthermore, box bottom, warning light, power switch, hard disk indicate light, and power light, can be installed on the corresponding locations of the motherboard. Further, two speakers and a disk drive device can be located on a side of the computer body. The keyboard input portion 30 is located on the surface of the computer body 90, and includes a plurality of keys to input characters to the computer body 90. The length of the keyboard input portion 30 is same as the length of the surface of the computer body 90. The width of the keyboard input portion 30 is less than the width of the surface of the computer body 90. The output port of the keyboard input portion 30 is electrically connected to the computer body 90 via an inside input port of the computer body 90.

In addition, to facilitate users convenient use of the portable computer 100, at least one input port and at least one outside output port can also be located at the side of the computer body 90. The port may be used to connect the outside mouse input device and/or keyboard to the computer body, to input another signal to the computer.

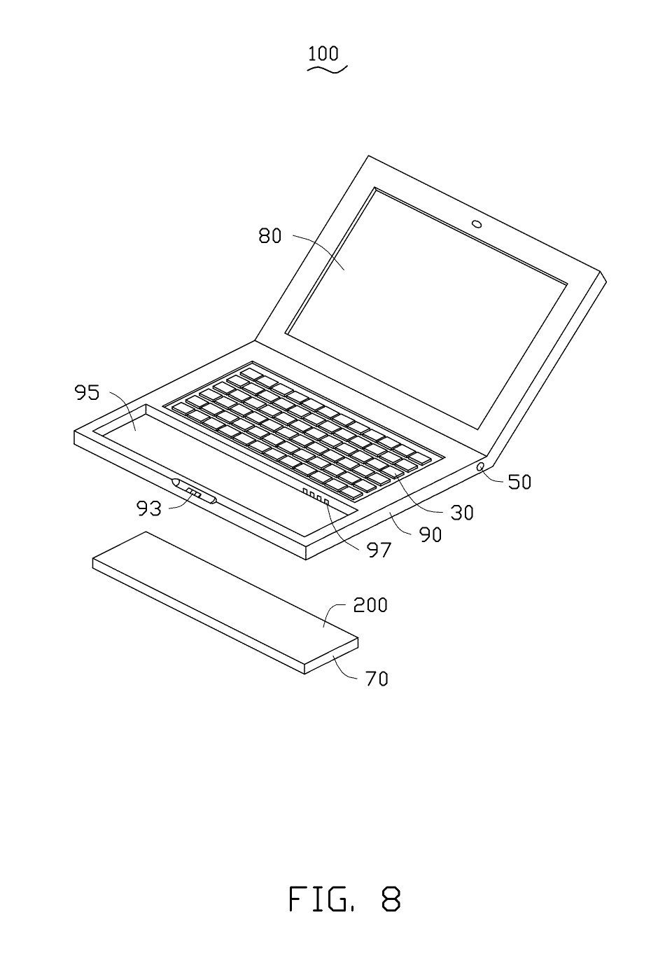

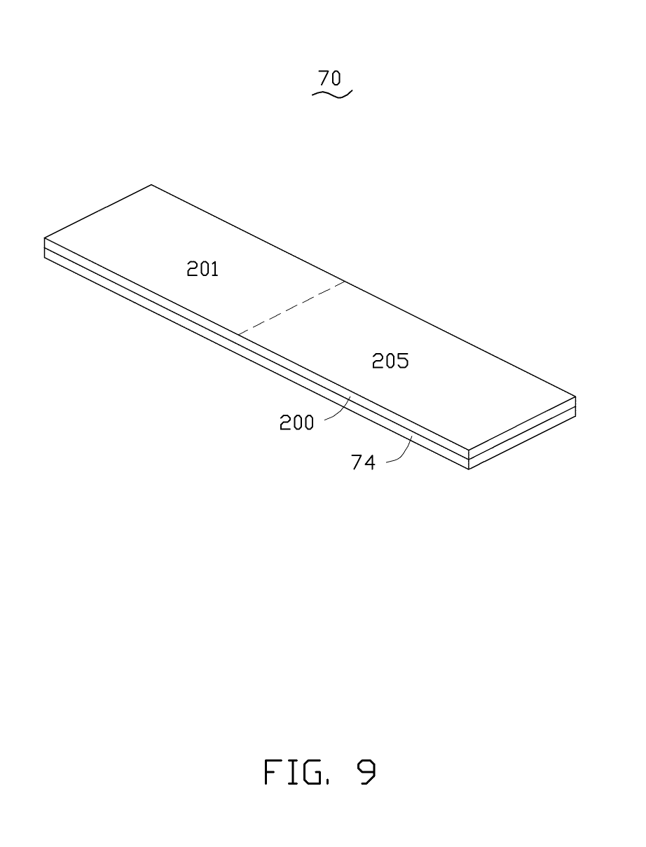

FIG. 8 and FIG. 9 show another embodiment of portable computer 100. In the embodiment, the portable computer 100 includes a touch input device 70. The touch input device 70 is a plug-in device, and can be plugged in to the surface of the computer body 90 of the portable computer 100.

In one embodiment, a hollow portion 95 is defined on the surface of the computer body 90. The touch input device 70 is a detachable and an individual component, and can be installed in the hollow portion 95 of the computer body 90 via buckle 93. The touch input device 70 can work in the situation of being detached from the computer body 90.

A plurality of contact electrodes 97 is located in the hollow portion 95 of the computer body 90. The touch input device 70 includes a plurality of contactors corresponding to the contact electrodes 97. When the touch input device 70 is installed in the hollow portion 95 of the computer body 90, the computer body 90 can be electrically connected to the touch input device 70.

In the embodiment, the touch input device 70 can also include a second display screen 74 integrated with the touch panel 200. Further, the touch input device 70 can also includes motherboard, CPU, memory, and other components, and can be installed with an operating system. The touch input device 70 can also include a built-in battery. When the touch input device 70 is detached from the computer body, the built-in battery provides power to the touch input device.

The touch input device 70 also includes wireless or Bluetooth model, and can input signals to the computer body via wireless or Bluetooth, to remotely control the display screen 80. The touch input device 70 can charge or discharge via wireless or Bluetooth.

The touch input device 70 can further include a plurality of expanded slots, and SD card slots, to read the information of a moving memory device and input the information to the computer body 90.

The touch panel 200 of touch input device 70 is similar to the first embodiment, and includes a plurality of touch function regions corresponding to different functions.

The touch input device 70 can further include with speaker and camera.

In the present embodiment, the touch input device 70 can be fastened in the hollow portion 95 on the surface of the computer body 90, via buckle 93. The touch input device 70 can input signal to the computer body 90 wirelessly, to achieve data input, and display on the display screen 80. The touch input device 70 can be detached from the computer body 90, and input signal to the computer body 90 wirelessly, to remote control the portable computer 100 to achieve functions. Besides, the touch panel 200 includes a plurality of touch function regions, to operate much more functions in remote.

It is to be understood that the above-described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The above-described embodiments illustrate the scope of the disclosure but do not restrict the scope of the disclosure.

What is claimed is:

1. A computer, comprising:
a display screen;
a computer body connected with the display screen vie a connecting piece;
a keyboard input portion; and
a touch input device comprising a touch panel, wherein the keyboard input portion and the touch panel are located on a same surface of the computer body, the touch panel extends from a first side to a second side of the surface opposite the first side, and covers, together with the keyboard input portion, a whole area of the surface of the computer body.

2. The computer of claim 1, wherein the touch panel and the keyboard input portion has a length similar to the computer body.

3. The computer of claim 1, wherein the touch panel defines at least two touch function regions.

4. The computer of claim 3, wherein the at least two touch function regions define different functions via different input coordinate signals detected by the touch panel, which makes the touch panel achieve different functions at different touch positions.

5. The computer of claim 3, wherein functions of the at least two touch function regions are pre-defined or controlled by software, and the functions of the at least two touch function regions is designed by users.

6. The computer of claim 3, wherein the at least two touch function regions are a mouse touch function region and a handwriting function region.

7. The computer of claim 1, wherein the touch panel comprises:
an insulated substrate comprising a first surface and a second surface opposite to each other;
a first conductive film being electrical resistance anisotropy, and located on the first surface of the insulated substrate; and
a second conductive film being electrical resistance anisotropy, and located on the second surface of the insulated substrate, wherein a minimum electrical resistance direction of the first conductive film is perpendicular to a minimum electrical resistance direction, at least one of the first conductive film and the second conductive film is a carbon nanotube film.

8. The computer of claim 7, wherein the carbon nanotube film comprises a plurality of carbon nanotubes extending along a same direction, and the extending direction of the carbon nanotubes is the minimum electrical resistance direction of the carbon nanotube film.

9. The computer of claim 8, wherein the plurality of carbon nanotubes are joined end-to-end along the extending direction by van der Waals attractive force therebetween.

10. The computer of claim 7, wherein the first conductive film comprises a plurality of strip-type conductive structures parallel to and spaced a distance with each other.

11. The computer of claim 10, wherein the plurality of strip-type conductive structures extend along the minimum electrical resistance direction of the first conductive film.

12. The computer of claim 10, wherein a ratio between a width of the strip-type conductive structure and the distance between the adjacent strip-type conductive structures 202 is a range from about 5% to about 50%.

13. The computer of claim 10, wherein a ratio between a width of the strip-type conductive structure and the distance between the adjacent strip-type conductive structures is a range from about 10% to about 20%.

14. The computer of claim 10, wherein the first conductive film is a patterned ITO film.

15. A computer, comprising:
a display screen;
a computer body connected with the display screen vie a connecting piece;
a keyboard input portion; and
a touch input device comprising a touch panel, wherein the keyboard input portion and the touch panel are located on a same surface of the computer body, the touch panel extends from a first side to a second side opposite to the first side of the surface, and covers the whole surface of the computer body with the keyboard input portion, the touch input device is fixed on the surface of the computer body and is detachable.

16. The computer of claim 15, wherein the touch panel defines at least two touch function regions.

17. The computer of claim 15, wherein the touch function device is fixed in a hollow portion on the surface of the computer body via buckle.

18. The computer of claim 17, wherein a plurality of contact electrodes is located in the hollow portion, the touch input device is electrically connected with the computer body via the plurality of contact electrodes.

19. The computer of claim 15, wherein the touch panel and the keyboard input portion has a length similar to the computer body.

20. The computer of claim 1, wherein the touch panel is close to the connecting piece, and the touch input device is away from the connecting piece.
